(19) United States
(12) Patent Application Publication
(10) Pub. No.: US 2005/0046991 A1
(43) Pub. Date: Mar. 3, 2005

(54) Information processing apparatus having function to control housing temperature

(75) Inventor: Takahiro Nakazato, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/927,530

(22) Filed: Aug. 27, 2004

(30) Foreign Application Priority Data
Aug. 29, 2003 (JP) 2003-307243

(51) Int. Cl. G11B 19/02

(52) U.S. Cl. 360/69

(57) ABSTRACT

An information processing apparatus includes a housing having a palm rest area and an area for input device placement, an input device provided in the area for input device placement, a disk drive device provided in the housing opposite at least one of the palm rest area and the area for input device placement, a detector which detects the temperature of at least one of the palm rest area and the area for input device placement, and a control unit which controls operations of the disk drive device based on the temperature detected by the detector.

### CROSS-REFERENCE TO RELATED APPLICATIONS

This application is based upon and claims the benefit of priority from prior Japanese Patent Application No. 2003-307243, filed Aug. 29, 2003, the entire contents of which are incorporated herein by reference.

### BACKGROUND OF THE INVENTION

1. Field of the Invention

The present invention relates to an information processing apparatus such as a notebook type personal computer.

2. Description of the Related Art

In recent years, portable information processing apparatuses such as notebook type portable personal computers have been developed. For the portable information processing apparatuses, efforts have been made to reduce the size and thickness of their housing.

Further, with the improved processing capabilities of a CPU (Central Processing Unit), the power consumption of the portable information processing apparatus has been steadily increased. On the other hand, to reduce the size and thickness of the housing of the portable information processing apparatus, a light material with a high thermal conductivity such as aluminum or magnesium is now used for the housing. Accordingly, heat from various ICs including the CPU is transferred to the housing, so that the temperature of the housing itself is prone to rise.

Thus, techniques to suppress a possible rise in the temperature of the housing have recently been emerging. Jpn. Pat. Appln. KOKAI Publication No. 2000-250658 discloses a technique to control driving of a fan and the clock frequency of the CPU in accordance with the temperature of the housing.

However, the fan is provided on a rear wall of the housing, so that the CPU is correspondingly mounted close to the rear wall of the housing. On the other hand, a palm rest with which a user's hand directly contacts is provided in the front of the housing. Thus, even if, for example, the clock frequency of the CPU is reduced, it is difficult that this immediately suppresses a possible rise in the temperature of the vicinity of the palm rest or a keyboard with which the user directly contacts.

### BRIEF SUMMARY OF THE INVENTION

According to an embodiment of the present invention, there is provided an information processing apparatus comprising a housing having a palm rest area and an area for input device placement, an input device provided in the area for input device placement, a disk drive device provided in the housing opposite at least one of the palm rest area and the area for input device placement, a detector which detects the temperature of at least one of the palm rest area and the area for input device placement, and a control unit which controls operations of the disk drive device based on the temperature detected by the detector.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the appearance of an information processing apparatus according to an embodiment of the present invention;

FIG. 2 is an exploded perspective view showing the structure of the information processing apparatus shown in FIG. 1;

FIG. 3 is a sectional view showing the structure of the information processing apparatus shown in FIG. 1;

FIG. 4 is a block diagram showing the system configuration of the information processing apparatus shown in FIG. 1;

FIG. 5 is a diagram illustrating an example of a process of controlling operations of a disk drive provided in the information processing apparatus shown in FIG. 1;

FIG. 6 is a diagram illustrating another example of a process of controlling operations of the disk drive provided in the information processing apparatus shown in FIG. 1;

FIG. 7 is a flow chart showing the procedure of the process of controlling operations of the disk drive provided in the information processing apparatus shown in FIG. 1;

FIG. 8 is a diagram illustrating an example of a process of controlling operations of a display controller provided in the information processing apparatus shown in FIG. 1;

FIG. 9 is a diagram illustrating another example of a process of controlling operations of the display controller provided in the information processing apparatus shown in FIG. 1; and

FIG. 10 is a flow chart showing the procedure of the process of controlling operations of the display controller provided in the information processing apparatus shown in FIG. 1.

### DETAILED DESCRIPTION OF THE INVENTION

An embodiment of the present invention will be described below with reference to the drawings.

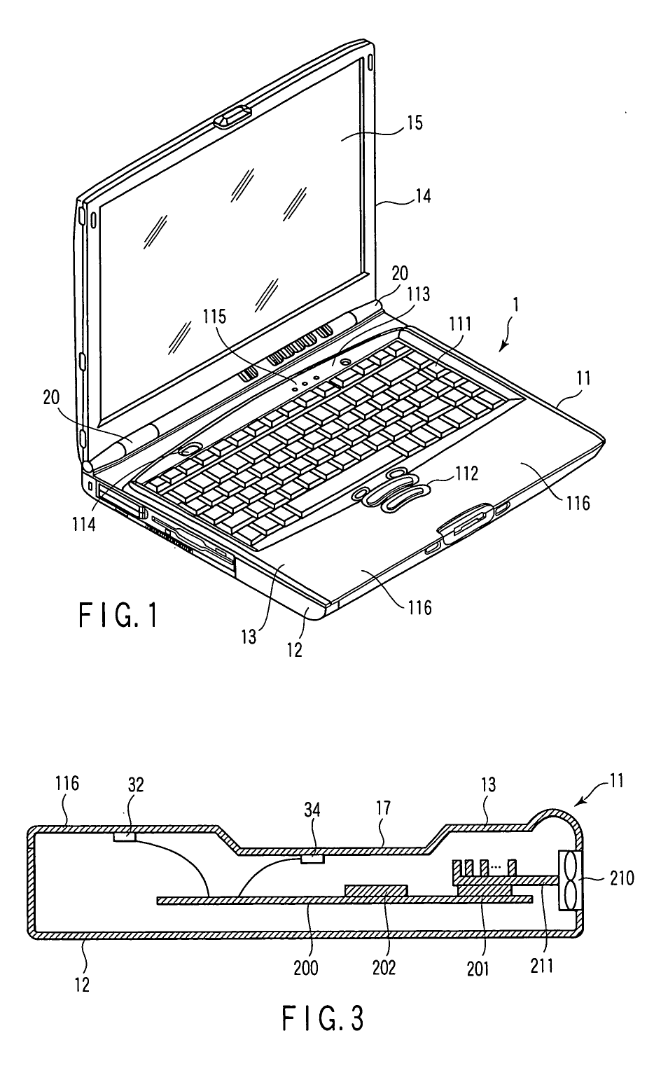

FIG. 1 is a perspective view showing the appearance of an information processing apparatus according to an embodiment of the present invention. The information processing apparatus has been implemented as a notebook type portable personal computer.

The portable personal computer 1 is composed of a computer main body 11 and a display unit 14. The computer main body 11 has a thin box-shaped housing. The housing includes a rectangular case 12 with an open top surface, and a cover 13 joined to the case 12 so as to cover the opening in the case 12. The case 12 is a base unit constituting a bottom wall, a right and left side walls, a front wall, and a rear wall of the computer main body 11. The cover constitutes a top wall of the computer main body 11.

A keyboard 111, a pointing device 112, and an indicator panel 113 are arranged on the cover 13. A power button 114 and a status LED (Light Emitting Diode) 115 are arranged in the indicator panel 113. Moreover, a palm rest area 116 is placed in the front of the cover 13. The palm rest area 116 is a space on which a user rests his or her hand when operating an input device (keyboard 111 or pointing device 112).

The display unit 14 is attached to the computer main body 11 and can be rotated, via a hinge portion 20 provided in the rear of the computer main body 11, between an illustrated open position in which the entire surface of the top wall of the computer main body 11 is exposed and a closed position in which the entire surface of the top wall of the computer main body 11 is covered by the display unit 14. In the open position, the keyboard 11 and the pointing device 112 are exposed.

The display unit 14 incorporates an LCD 15 (Liquid Crystal Display). A display screen of the LCD 15 is located almost in the center of the display unit 14.

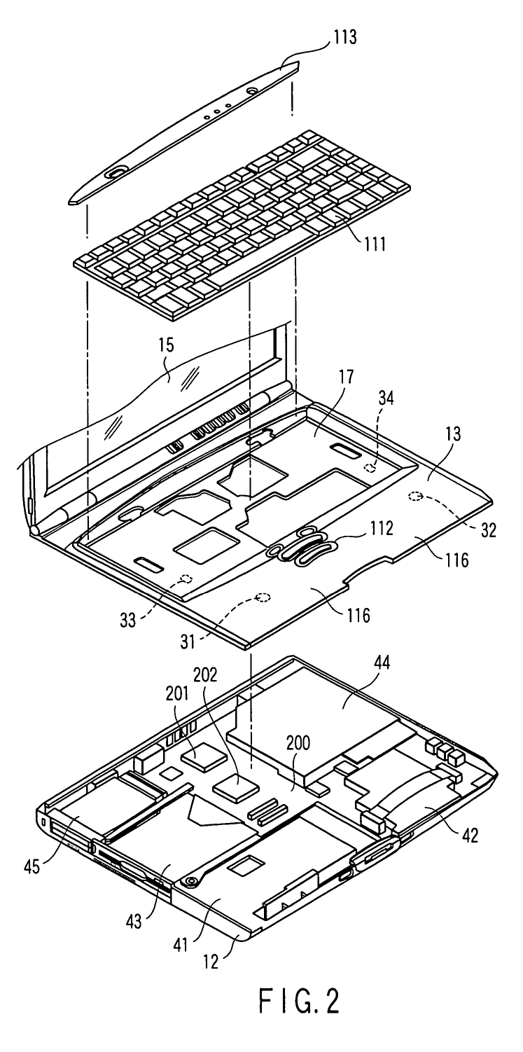

FIG. 2 is an exploded perspective view of the computer 1. As shown in FIG. 2, a rectangular concave 17 is formed, as an area for input device placement, in the cover 13 constituting the top wall of the computer main body 1. The keyboard 111, having a large number of keys, is placed in the concave 17. Further, the inner surface of the top wall of the computer main body 1, that is, the back surface of the cover 13, is provided with four temperature sensors 31, 32, 33, and 34 that detect the surface temperature of the top wall.

The temperature sensor 31 is a detector that detects the temperature of the left side of the palm rest area 116. The temperature sensor 31 is provided on the back surface of the cover 13 opposite the left side of the palm rest area 116. The temperature sensor 32 is a detector that detects the temperature of the right side of the palm rest area 116. The temperature sensor 32 is provided on the back surface of the cover 13 opposite the right side of the palm rest area 116.

The temperature sensors 33 and 34 are detectors that detect the temperature of the keyboard 111. The temperature sensor 33 is provided on the back surface of the concave 17 opposite the left side of the concave 17. The temperature sensor 34 is provided on the back surface of the concave 17 opposite the right side of the concave 17. The temperature sensors 33 and 34 may be provided on the back surface of the keyboard 111.

As shown in the figure, in the case 12, there are provided a battery 41, a hard disk drive (HDD) 42, a flexible disk drive (FDD) 43, a CD/DVD drive 44, and a PC card slot 45. The hard disk drive 42 is placed in the case 12 opposite the right side of the palm rest area 116. Thus, heat generated by the hard disk drive 42 is transferred to the palm rest area 116 to raise the temperature of the palm rest area 116. In the hard disk drive 42, a disk always rotates, thus the quantity of heat generated by the hard disk drive 42 is larger than that generated by the FDD 43 or the CD/DVD drive 44.

In the present embodiment, operations of the hard disk drive are controlled in order to suppress an increase in the temperature of the palm rest area 116 and keyboard 111 above a predetermined value. Specifically, the present embodiment executes a process of stopping the rotation of a motor for the hard disk drive 42 and a process of controlling the operation speed (data transfer speed) of the hard disk drive 42. Further, since the hard disk drive 42 consumes a relatively high power, the quantity of heat generated by the battery 41, located below the palm rest area, can be reduced by controlling the operation of the hard disk drive 42 so as to reduce its power consumption.

Thus, a possible rise in the temperature of the palm rest area 116 and keyboard 111 can be efficiently suppressed by controlling the operation of the hard disk drive 42, which directly affects the temperature of the palm rest area 116 and keyboard 111.

Furthermore, the case 12 accommodates a printed circuit board 200 on which a large number of electronic parts are mounted. As shown in the figure, a CPU 201 and a graphics controller 202 are mounted on the printed circuit board 200. The CPU 201 and the graphics controller 202 consume much more power and generate much more heat than other ICs.

FIG. 3 shows the sectional structure of the computer main body 11 as viewed from a right side. A fan 210 is provided on the rear wall of the computer main body 11. Heat from the CPU 201 is radiated to the exterior through the fan 210 and a heat sink 211 placed on the CPU 201. The graphics controller 202 is mounted on the circuit board 200 opposite the concave 17. Thus, heat generated by the graphics controller 202 is prone to be transferred to the keyboard 111. In the present embodiment, not only the operation of the hard disk drive 42 but also the operation speed of the graphics controller 202 are controlled. Accordingly, a possible rise in the temperature of the palm rest area 116 and keyboard 111 can be more efficiently suppressed.

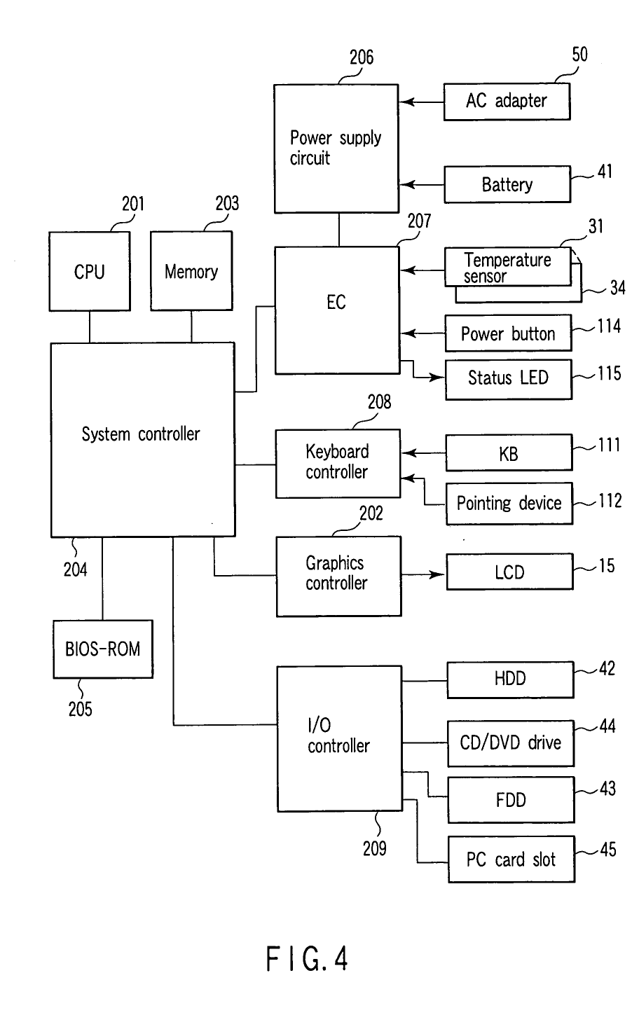

Now, the system configuration of the computer 1 will be described with reference to FIG. 4. On the circuit board 200, there are mounted the CPU 201, the graphics controller 202, a memory 203, a system controller 204, a BIOS-ROM 205, a power supply circuit 206, an embedded controller (EC) 207, a keyboard controller 208, an I/O controller 209, and the like.

The CPU 201 is a processor provided to control operations of the computer 1. The CPU 201 executes an operating system (OS) and application programs/utility programs loaded into the memory 203 from the hard disk drive (HDD) 42. The CPU 201 also executes a BIOS (Basic Input Output System) stored in the BIOS-ROM 205.

The graphics controller 202 is a display controller that controls the LCD 15, functioning as a display monitor for the computer 1. The system controller 204 controls communications between components, the memory 203, and the like. The power supply circuit 206 generates power to be supplied to each component from a power of the battery 41 or an external AC adapter.

The embedded controller (EC) 207 controls power-on/off of the computer 1 in accordance with an operation of the power button 114. The EC 207 has a function to cause the status LED 115 to indicate the status of the computer 1 such as a power supply status or the amount of power remaining in the battery. Moreover, the embedded controller (EC) 207 has a function to control the operation of the hard disk drive (HDD) 42 and the operation speed of the graphics controller 202 on the basis of the temperature of the surface (palm rest area and keyboard) of the top wall of the computer main body 11 which temperature is detected by the temperature sensors 31 to 34.

The keyboard controller 208 controls the keyboard (KB) 111 and the pointing device 112 under the control of the CPU 201. The I/O controller 209 controls the hard disk drive (HDD) 42, the flexible disk drive (FDD) 43, and the CD/DVD drive 44 under the control of the CPU 201. The hard disk drive (HDD) 42, the flexible disk drive (FDD) 43, and the CD/DVD drive 44 are used as auxiliary storage devices for the computer 1. The I/O controller 209 also controls a PC card inserted into a PC card slot 45 under the control of the CPU 201.

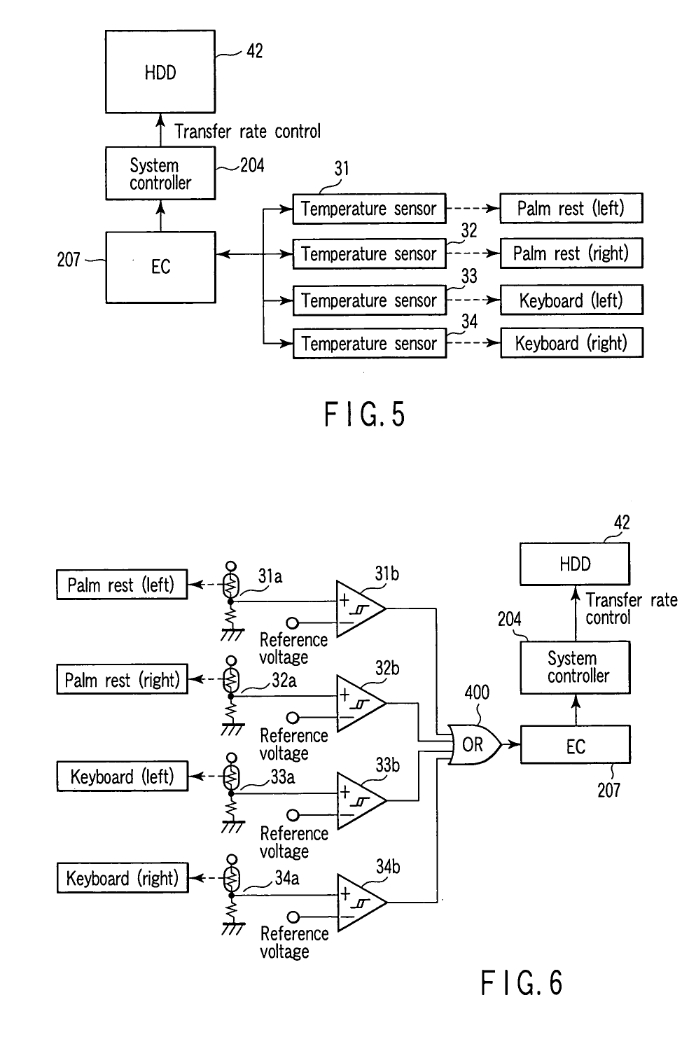

Now, with reference to FIG. 5, description will be given of control of operations of the hard disk drive (HDD) 42 which control is executed by the EC 207. The EC 207 contains a control processor. The control processor controls the operation of the hard disk drive (HDD) 42 by executing firmware stored in a nonvolatile memory in the EC 207.

The EC 207 communicates with each of the temperature sensors 31 to 34 to acquire detected temperatures from the temperature sensors 31 to 34. As described above, the temperature sensors 31 and 32 detect the temperatures of the left and right sides, respectively, of the palm rest area 116. The temperature sensors 33 and 34 detect the temperatures of the left and right sides, respectively, of the keyboard 111. If the temperature of the left or right side of the palm rest area 116 or keyboard 111 becomes a predetermined upper limit temperature (Tu: for example, 45° C.), the EC 207 starts a process of reducing the operation speed (data transfer speed) of the hard disk drive (HDD) 42 through the system controller 204.

The hard disk drive (HDD) 42 has a plurality of data transfer modes with different data transfer rates. For example, the hard disk drive (HDD) 42 has the following data transfer modes:
Mode 1: DMA (Direct Memory Access) 100
Mode 2: DMA 66
Mode 3: DMA 33
Mode 4: PIO (Program I/O)

The mode 1 is a transfer mode with the highest data transfer rate in which a disk is also rotated at a high speed. In the mode 1, the hard disk drive (HDD) consumes the most power and generates the most heat. The decreasing order of the data transfer rate is the mode 1, mode 2, mode 3, and mode 4. The decreasing order of the power consumption and heating value of the hard disk drive (HDD) is also the mode 1, mode 2, mode 3, and mode 4.

The EC 207 can switch the data transfer mode among the modes 1, 2, 3, and 4 by setting a command specifying a data transfer mode, in the hard disk drive (HDD) 42 through the system controller 204 and the I/O controller 209. A default data transfer mode for the hard disk drive (HDD) 42 is the mode 1 (high-rate transfer mode).

If the temperature of the left or right side of the palm rest area 116 or keyboard 111 becomes the predetermined upper limit temperature (Tu: for example, 45° C.) or higher, the EC 207 switches the data transfer mode of the hard disk drive (HDD) 42 to the mode 2 in order to reduce the data transfer rate of the hard disk drive (HDD) 42. The EC 207 switches the data transfer mode at specified time intervals in order of the mode 2, mode 3, and mode 4 so as to sequentially reduce the data transfer rate of the hard disk drive (HDD) 42 until all the temperatures of the left and right sides of the palm rest area 116 and keyboard 111 become a predetermined lower limit temperature (Tl: for example, 40° C.) or lower. If this data transfer rate down control successfully reduces all the temperatures of the left and right sides of the palm rest area 116 and keyboard 111 to the predetermined lower limit temperature (Tl: for example, 40° C.) or lower, then the EC 207 switches the data transfer mode of the hard disk drive (HDD) 42 so as to increase the data transfer rate of the hard disk drive (HDD) 42. With this data transfer rate up control, the data transfer mode is switched at specified time intervals so as to sequentially increase the data transfer rate of the hard disk drive (HDD) 42 until one of the temperatures of the left and right sides of the palm rest area 116 and keyboard 111 becomes the predetermined upper limit temperature (Tu: for example, 45° C.) or higher.

All the temperatures of the left and right sides of the palm rest area 116 and keyboard 111 may be averaged so as to control the data transfer rate of the hard disk drive (HDD) in accordance with the calculated average temperature.

Alternatively, the data transfer rate down control process may be started when one of the temperatures of the left and right sides of the palm rest area 116 and keyboard 111 becomes the predetermined upper limit temperature (Tu: for example, 45° C.) or higher. Then, the data transfer mode may be returned to the mode 1 (high-rate transfer mode) when this data transfer rate down control process successfully reduces all the temperatures of the left and right sides of the palm rest area 116 and keyboard 111 below 45° C.

In this case, the execution of the data transfer rate down control process can be controlled using a simple hardware configuration such as the one shown in FIG. 6. Specifically, the temperature sensors 31 to 34 are thermistors 31a to 34a such as those shown in FIG. 6. Outputs of the thermistors 31a to 34a are connected to comparators 31b to 34b, respectively. Each of the comparators 31b to 34b compares an output voltage from the corresponding thermistor with a reference voltage. The comparator then outputs a signal for a logic “1” or “0” depending on the result of the comparison. The value of the reference voltage is determined so that when the thermistor detects a temperature of 45° C. or higher, the comparator outputs the logic “1”.

An output from each of the comparators 31b to 34b is transmitted to the EC 207 through an OR circuit 400. The EC 207 monitors the output from the OR circuit 400 to start the data transfer rate down control process when the output from the OR circuit 400 changes to the logic “1”. The data transfer rate down control process continues until the output from the OR circuit 400 changes to the logic “0”. When the output from the OR circuit 400 becomes the logic “0”, the EC 207 returns the data transfer mode of the hard disk drive (HDD) 42 to the mode 1 (high-rate transfer mode).

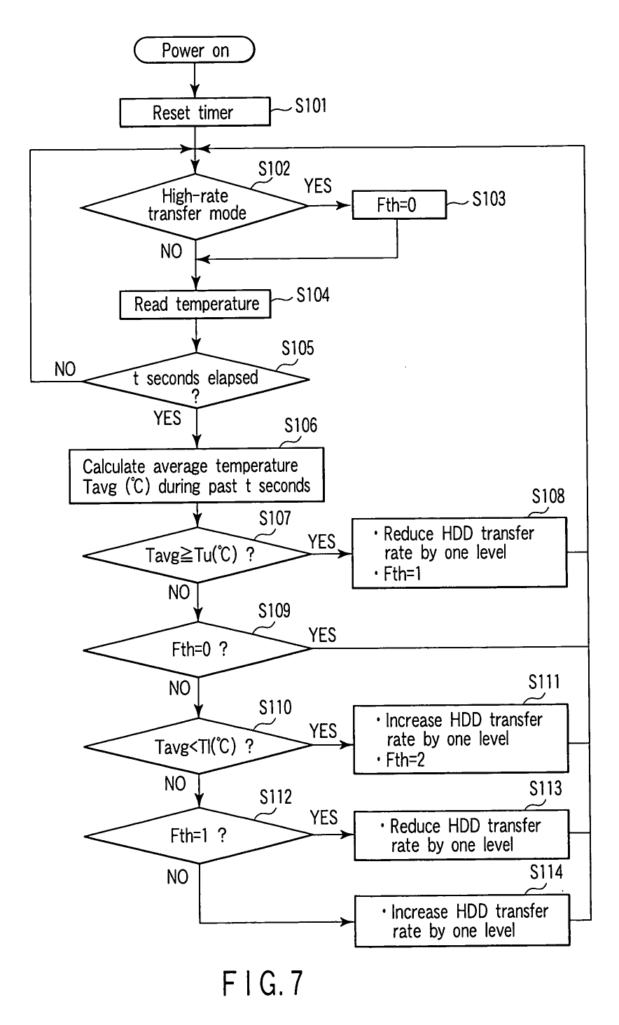

Next, with reference to the flow chart in FIG. 7, description will be given of the procedure of a process of controlling the data transfer rate of the hard disk drive (HDD) 42. In this description, all the temperatures of the left and right sides of the palm rest area 116 and keyboard 111 are averaged so as to control the data transfer rate of the hard disk drive (HDD) 42 in accordance with the calculated average temperature.

When the computer 1 is powered on, the EC 207 first resets a built-in timer (step S101). Then, the EC 207 determines whether or not the data transfer mode of the hard disk drive (HDD) is the mode 1 (high-rate transfer mode) (step S102). If the data transfer mode of the hard disk drive (HDD) is the mode 1 (high-rate transfer mode), the EC 207 sets an operation speed control status flag Fth to 0 (step S103). Fth=0 indicates that the operation speed control is not being executed (that is, the data transfer mode of the HDD is the high-rate transfer mode).

Then, the EC 207 executes a process of reading a detected temperature from each of the temperature sensors 31 to 34 (step S104). The temperature reading process is repeated at specified time intervals until t seconds (for example, 30 seconds) elapse (step S105). Then, the EC207 calculates the average surface temperature Tavg° C. of the palm rest area 116 and keyboard 111 during the past t seconds (step S106).

The EC 207 determines whether or not the average surface temperature Tavg° C. is at least the upper limit temperature Tu (for example, 45° C.) (step S107). If the average surface temperature Tavg° C. is at least the upper limit temperature Tu (YES in the step S107), the EC 207 switches the data transfer mode of the HDD 42 from mode 1 (high-rate transfer mode) to mode 2. Thus, the data transfer rate of the HDD 42 is reduced by one level (step S108). In the step S108, the operation speed control status flag Fth is also set to 1. Fth=1 indicates that the data transfer rate down control process is being executed. If the average surface temperature Tavg° C. remains at least the upper limit temperature Tu even after the data transfer rate down control process has been started, the process in the step S108 is repeated to switch the data transfer mode of the HDD 42 in order of the mode 2, mode 3, and mode 4.

If the average surface temperature Tavg° C. is lower than the upper limit temperature Tu (NO in the step S107), the EC 207 determines whether or not Fth is 0 (step S109). If Fth is 0 (YES in the step S109), the EC 207 executes nothing. On the other hand, if Fth is not 0 (NO in the step S109), the EC 207 determines whether or not the average surface temperature Tavg ° C. is lower than the lower limit temperature Tl (for example, 40° C.) (step S110). If the average surface temperature Tavg° C. is lower than the lower limit temperature Tl (for example, 40° C.) (YES in the step S110), the EC 207 switches the data transfer mode of the HDD 42 from the current mode to a one-level higher mode. Thus, the data transfer rate of the HDD 42 is increased by one level (step S111). In the step S111, the operation speed control status flag Fth is also set to 2. Fth=2 indicates that the data transfer rate up control process is being executed.

On the other hand, if the average surface temperature Tavg° C. is at least the lower limit temperature Tl (for example, 40° C.) (NO in the step S110), the EC 207 determines, with reference to the operation speed control status flag, whether the data transfer rate up control process or the data transfer rate down control process is being executed (step S112). If Fth=1, that is, the data transfer rate down control process is being executed (YES in the step S112), the EC 207 reduces the data transfer rate of the HDD 42 by one level (step S113). If Fth=2, that is, the data transfer rate up control process is being executed (NO in the step S112), the EC 207 increases the data transfer rate of the HDD 42 by one level (step S114).

In this manner, a possible rise in the temperature of the palm rest area 116 and keyboard 111 can be efficiently suppressed by controlling the data transfer rate of the HDD 42, which directly affects the temperature of the palm rest area 116 and keyboard 111.

In the present embodiment, the operation speed of the graphics controller 202 is controlled in addition to the data transfer rate of the HDD 42.

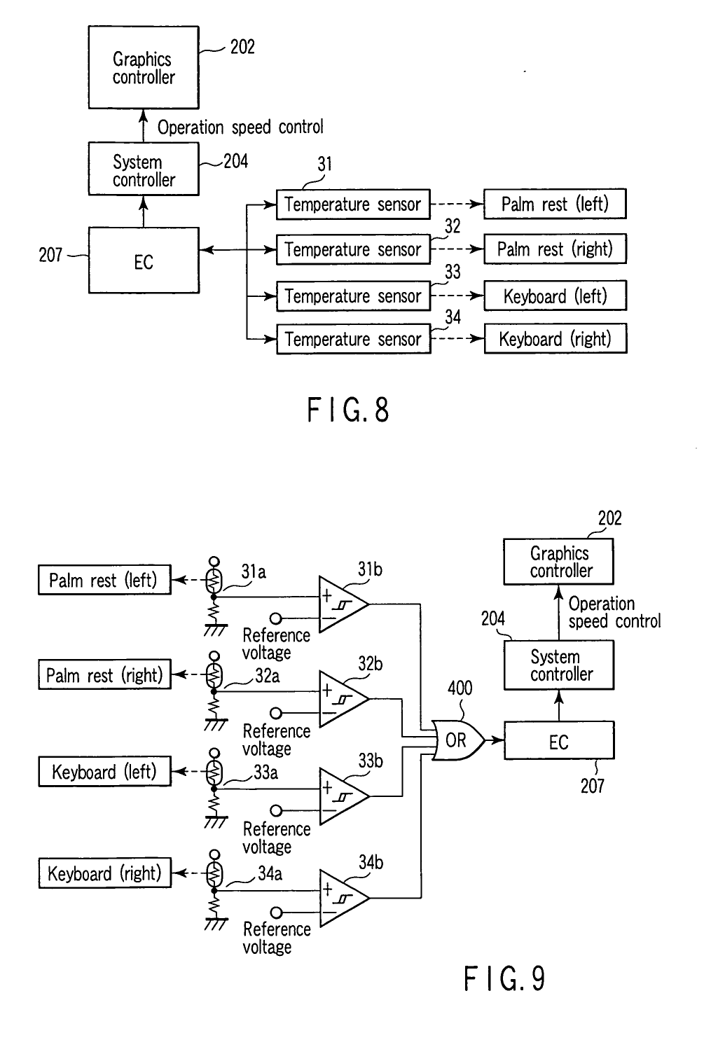

Now, with reference to FIG. 8, description will be given of the control of the operation of the graphics controller 202 which control is executed by the EC 207. If any of the temperatures of the left and right sides of the palm rest area 116 and keyboard 111 becomes the predetermined upper limit temperature (Tu: for example, 45° C.) or higher, the control processor of the EC 107 starts not only a process of reducing the data transfer rate of the HDD 42 but also a process of reducing the operation speed of the graphics controller 202.

The graphics controller 202 has a plurality of operation modes with different power consumptions. For example, the graphics controller 202 has the following operation modes:
Performance mode
Power saving mode 1
Power saving mode 2
Power saving mode 3

The performance mode is an operation mode with the highest operation speed. In the performance mode, the graphics controller 202 consumes the most power and generates the most heat. The decreasing order of the operation speed is the performance mode, power saving modes 1, power saving mode 2, and power saving mode 3. The decreasing order of the power consumption and heating value of the graphics controller 202 is also the performance mode, power saving modes 1, power saving mode 2, and power saving mode 3.

The EC can switch the operation mode of the graphics controller 202 among the performance mode and power saving modes 1, 2, and 3 by setting a command specifying an operation mode in the graphics controller 202. A default operation mode of the graphics controller 202 is the performance mode.

If any of the temperatures of the left and right sides of the palm rest area 116 and keyboard 111 becomes the predetermined upper limit temperature (Tu: for example, 45° C.) or higher, the EC 207 starts the data transfer rate down control process of reducing the data transfer rate of the hard disk drive (HDD) 42. The EC also switches the operation mode of the graphics controller 202 from performance mode to power saving mode 1 so as to reduce the operation speed of the graphics controller 202. The EC 207 switches the operation mode of the graphics controller 202 in order of the power saving mode 1, power saving mode 2, and power saving mode 3 at specified time intervals so as to sequentially reduce the operation speed of the graphics controller 202 until all the temperatures of the left and right sides of the palm rest area 116 and keyboard 111 become the predetermined lower limit temperature (Tl: for example, 40° C.) or lower. If the data transfer rate down control process of the HDD 42 and the operation speed down control process of the graphics controller 202 successfully reduce all the temperatures of the left and right sides of the palm rest area 116 and keyboard 111 to the predetermined lower limit temperature (Tl: for example, 40° C.) or lower, then the EC 207 starts the data transfer rate up control process of increasing the data transfer rate of the hard disk drive (HDD) 42. The EC also starts the operation speed up control process of increasing the operation speed of the graphics controller 202. In the operation speed up control process, the operation mode of the graphics controller 202 is switched at specified time intervals so as to sequentially increase the operation speed of the graphics controller 202 until one of the temperatures of the left and right sides of the palm rest area 116 and keyboard 111 becomes the predetermined upper limit temperature (Tu: for example, 45° C.) or higher.

As in the case of the control of the data transfer rate of the hard disk drive (HDD) 42, all the temperatures of the left and right sides of the palm rest area 116 and keyboard 111 may be averaged so as to control the operation speed of the graphics controller 202 in accordance with the calculated average temperature.

Furthermore, as shown in FIG. 9, the operation speed of the graphics controller 202 may be controlled utilizing the thermistors 31a to 34a, the comparators 31b to 34b, and the OR circuit 400, described in FIG. 6.

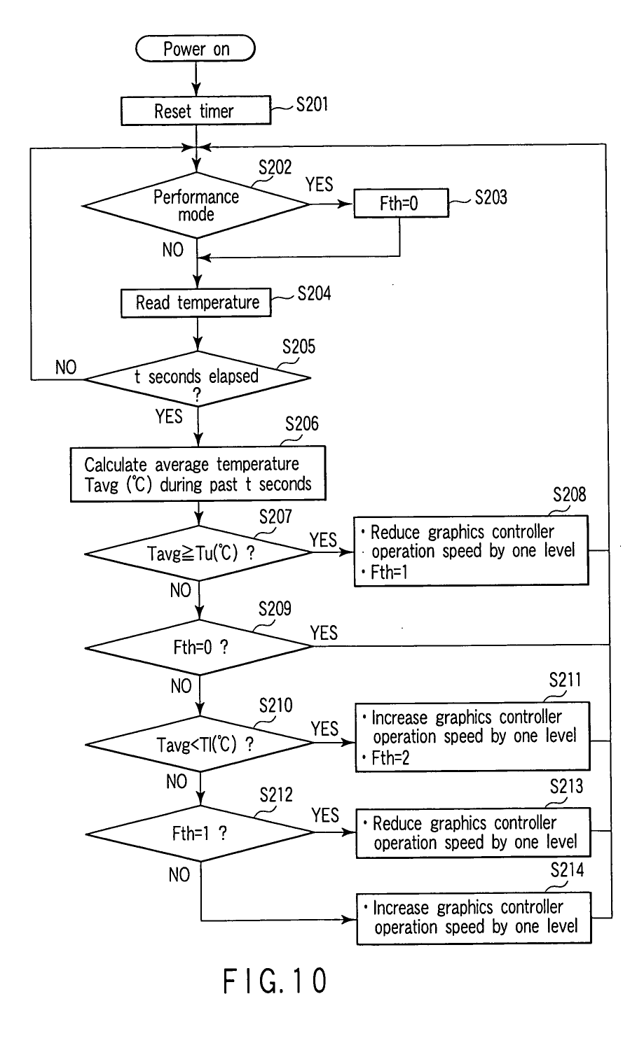

Next, with reference to the flow chart in FIG. 10, description will be given of the procedure of the process of controlling the operation speed of the graphics controller 202. The control of the operation speed of the graphics controller 202 is actually executed in connection with the control of the data transfer rate of the HDD 42. However, description will be given below only of the control of the operation speed of the graphics controller 202. In the description below, it is assumed that all the temperatures of the left and right sides of the palm rest area 116 and keyboard 111 are averaged so as to control the operation speed of the graphics controller 202 in accordance with the calculated average temperature.

When the computer 1 is powered on, the EC 207 first resets the built-in timer (step S201). Then, the EC 207 determines whether or not the operation mode of the graphics controller 202 is the performance mode (step S202). If the operation mode of the graphics controller 202 is the performance mode, the EC 207 sets the operation speed control status flag Fth to 0 (step S203). Fth=0 indicates that the operation speed control is not being executed (that is, the operation mode of the graphics controller 202 is the performance mode).

Then, the EC 207 executes a process of reading a detected temperature from each of the temperature sensors 31 to 34 (step S204). The temperature reading process is repeated at specified time intervals until t seconds (for example, 30 seconds) elapse (step S205). Then, the EC207 calculates the average surface temperature Tavg° C. of the palm rest area 116 and keyboard 111 during the past t seconds (step S206).

The EC 207 determines whether or not the average surface temperature Tavg° C. is at least the upper limit temperature Tu (for example, 45° C.) (step S207). If the average surface temperature Tavg° C. is at least the upper limit temperature Tu (YES in the step S207), the EC 207 switches the data transfer mode of the graphics controller 202 from performance mode to power saving mode 1. Thus, the operation speed of the graphics controller 202 is reduced by one level (step S208). In the step S208, the operation speed control status flag Fth is also set to 1. Fth=1 indicates that the operation speed down control process is being executed. If the average surface temperature Tavg° C. remains at least the upper limit temperature Tu even after the operation speed down control process has been started, the process in the step S208 is repeated to switch the operation mode of the graphics controller 202 in order of the power saving mode 1, power saving mode 2, and power saving mode 3.

If the average surface temperature Tavg° C. is lower than the upper limit temperature Tu (NO in the step S207), the EC 207 determines whether or not Fth is 0 (step S209). If Fth is 0 (YES in the step S209), the EC 207 executes nothing. On the other hand, if Fth is not 0 (NO in the step S209), the EC 207 determines whether or not the average surface temperature Tavg ° C. is lower than the lower limit temperature Tl (for example, 40° C.) (step S210). If the average surface temperature Tavg° C. is lower than the lower limit temperature Tl (for example, 40° C.) (YES in the step S210), the EC 207 switches the operation mode of the graphics controller 202 from the current operation mode to a one-level higher operation mode. Thus, the operation speed of the graphics controller 202 is increased by one level (step S211). In the step S211, the operation speed control status flag Fth is also set to 2. Fth=2 indicates that the operation speed up control process is being executed.

On the other hand, if the average surface temperature Tavg° C0 is at least the lower limit temperature Tl (for example, 40° C.) (NO in the step S210), the EC 207 determines, with reference to the operation speed control status flag, whether the operation speed up control process or the operation speed down control process is being executed (step S212). If Fth=1, that is, the operation speed down control process is being executed (YES in the step S212), the EC 207 reduces the operation speed of the graphics controller 202 by one level (step S213). If Fth=2, that is, the operation speed up control process is being executed (NO in the step S212), the EC 207 increases the operation speed of the graphics controller 202 by one level (step S214).

In this manner, a possible rise in the temperature of the palm rest area 116 and keyboard 111 can be efficiently suppressed by controlling the operation speed of the graphics controller 202, which directly affects the temperature of the palm rest area 116 and keyboard 111.

Here, it is assumed that the operation speed control of the graphics controller 202 and data transfer rate control of the HDD 42 are both executed. In this case, in each of the steps S208 and S213, shown in FIG. 10, the following two processes are executed: the process of reducing the operation speed of the graphics controller 202 by one level and the process of reducing the data transfer rate of the HDD 42 by one level. Likewise, in each of the steps S211 and S214, shown in FIG. 10, the following two processes are executed: the process of increasing the operation speed of the graphics controller 202 by one level and the process of increasing the data transfer rate of the HDD 42 by one level. The operation speed control status flag Fth can be used both for the control of the operation speed of the graphics controller and for the control of the data transfer rate of the HDD 42.

It is unnecessary to simultaneously control the operation speed of the graphics controller 202 and the data transfer rate of the HDD 42. For example, it is possible to first start the control that reduces the data transfer rate of the HDD 42 and then start the control that reduces the operation speed of the graphics controller 202 if the average surface temperature Tavg° C. remains at least the upper limit temperature Tu even after the data transfer rate of the HDD 42 has been reduced. Alternatively, temperature control modes may be provided including a temperature control mode 1 in which only the HDD 42 is controlled, a temperature control mode 2 in which only the graphics controller 202 is controlled, and a temperature control mode 3 in which both HDD 42 and graphics controller 202 are controlled so that the user can specify a mode to be used.

Furthermore, the HDD 42 may be provided in the case 12 opposite the concave 17, in which the keyboard 111 is accommodated. The graphics controller 202 may be provided on the circuit board 200 opposite the palm rest area 116. In place of the concave 17, an opening in which the keyboard 111 is accommodated may be provided on the cover 13 as an area for input device placement. In this case, the bottom wall of the keyboard 111, in combination with the cover 13, constitutes the top wall of the computer main body 11. The temperature sensors 33 and 34 may be provided on the inner surface of the bottom wall of the keyboard 111.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
a housing having a palm rest area and an area for input device placement;
an input device provided in the area for input device placement;
a disk drive device provided in the housing opposite at least one of the palm rest area and the area for input device placement;
a detector which detects the temperature of at least one of the palm rest area and the area for input device placement; and
a control unit which controls operations of the disk drive device based on the temperature detected by the detector.

2. The information processing apparatus according to claim 1, wherein the disk drive device includes a hard disk drive device.

3. The information processing apparatus according to claim 1, wherein the control unit is configured to control the data transfer rate of the disk drive device based on the temperature detected by the detector.

4. The information processing apparatus according to claim 1, wherein the control unit includes means for controlling the disk drive device to reduce the operation speed of the disk drive device if the temperature detected by the detector is at least a first temperature and means for controlling the disk drive device to increase the operation speed of the disk drive device if the temperature detected by the detector is reduced to a second temperature lower than the first temperature.

5. The information processing apparatus according to claim 1, wherein the disk drive device has a plurality of transfer modes with different data transfer rates, and
the control unit is configured to switch the transfer mode of the disk drive device among the plurality of transfer modes based on the temperature detected by the detector.

6. The information processing apparatus according to claim 1, wherein the input device includes a keyboard.

7. The information processing apparatus according to claim 1, wherein the detector is placed on an inner surface of the housing opposite the palm rest area.

8. The information processing apparatus according to claim 1, wherein the detector is placed on an inner surface of the housing opposite the area for input device placement.

9. The information processing apparatus according to claim 1, further comprising:
a display device rotatably attached to the housing;
a printed circuit board provided in the housing;
a display controller which is mounted on the printed circuit board and controls the display device; and
a unit which controls the operation speed of the display controller based on the temperature detected by the detector.

10. The information processing apparatus according to claim 9, wherein the display controller is placed on the printed circuit board opposite the area for input device placement.

11. An information processing apparatus comprising:
a housing having a palm rest area and an area for input device placement;
an input device provided in the area for input device placement;
a printed circuit board which is provided in the housing;
a disk drive device provided in the housing opposite at least one of the palm rest area and the area for input device placement;
a display controller provided on the printed circuit board opposite at least one of the palm rest area and the area for input device placement to control the display device;
a detector which detects the temperature of at least one of the palm rest area and the area for input device placement; and
a control unit which controls operations of at least one of the disk drive device and the display controller based on the temperature detected by the detector.
